(19) United States
(12) Patent Application Publication
(10) Pub. No.: US 2003/0226438 A1
(43) Pub. Date: Dec. 11, 2003

(54) Automatic workpiece cutting apparatus

(76) Inventor: Steven L. Adams, Leander, TX (US)

Correspondence Address: S. Michael Bender, P.O. Box 530399, St. Petersburg, FL, 33747, US

(21) Appl. No.: 10/445,668

(22) Filed: May 27, 2003

Related U.S. Application Data
(60) Provisional application No. 60/387,461, filed on Jun. 11, 2002.

(51) Int. Cl. B23D 7/00

(52) U.S. Cl. 83/746

(57) ABSTRACT

An automatic cutting apparatus is provided for cutting a workpiece and includes a marked line on the workpiece, a saw table, a saw unit, and a rotatable shaft supporting the saw unit. A first linear direction beam permits movement of the saw unit in a first direction, and a second linear direction beam permits movement of the saw unit in a second direction. A marked line sensor unit is connected to the saw unit. An electrically powered drive assembly is responsive to the marked line sensor unit which is responsive to the marked line on the marked workpiece. The electrically powered drive assembly automatically drives the saw unit along the first linear direction beam and the second linear direction beam. In this way, the saw blade automatically advances along the marked line and cuts the workpiece in accordance with the marked pattern on the workpiece without manually guiding the cutting tool unit.

### CROSS-REFERENCE TO RELATED APPLICATION

This application claims priority based upon my copending Provisional Application Serial No. 60/387,461; filed Jun. 11, 2002.

### BACKGROUND OF THE INVENTION

1. Field of the Invention

The present invention relates generally to cutting tools and, more particularly, to cutting tools especially adapted for automatically cutting complex patterns in a workpiece.

2. Description of the Prior Art

Cutting a complex pattern in a workpiece, such as a sheet of wood, plastic, or metal, is a manufacturing operation that is carried out in a wide variety of contexts. Traditionally, cutting complex patterns have been done by relying upon hand-eye coordination of a workman using a hand tool to manually cut a workpiece. To avoid the stress and fatigue upon a workman when manually cutting a workpiece in a complex pattern, it would be desirable to have complex patterns cut automatically by a machine without the need to stress and fatigue a workman during a complex manual cutting operation.

Throughout the years, a number of innovations have been developed relating to aiding a workman in the manual cutting of a workpiece, and the following U.S. patents are representative of some of those innovations: U.S. Pat. Nos. 2,806,492, 3,638,692, and 4,833,782. More specifically, U.S. Pat. No. 2,806,492 discloses means for projecting a light pattern on a workpiece that is to be machined by a machine tool. Once the light pattern in on the workpiece, the workman guides the workpiece along the tool. This device employs the hand-eye coordination of the workman to control the workpiece.

U.S. Pat. No. 3,638,692 discloses a device which projects one of more shadow lines on a workpiece to help a workman guide a machine tool with respect to the workpiece. This is another device that aids the hand-eye coordination of the workman as the workman manually controls the workpiece.

U.S. Pat. No. 4,833,782 discloses a hand-held saber saw that includes a light that projects a straight line light pattern onto a workpiece. The is another device that aids the hand-eye coordination of the workman as the workman manually controls the saber saw as it cuts the workpiece. It is noted that only a straight line light pattern is projected. Such a device is not useful for aiding the workman in making a non-linear cut on the workpiece. In this respect, it would be desirable if a device were provided which facilitates making a complex non-linear cut on a workpiece.

Aside from the patents discussed above, the following U.S. patents disclose machines which perform cutting actions on a workpiece automatically: U.S. Pat. Nos. 3,707,999 and 3,840,170. More specifically, U.S. Pat. No. 3,707,999 discloses machinery which employs a rotating drum, a conveyor assembly, and a shadow line on lumber for automatically cutting straight line cuts in lumber. As stated above, it would be desirable to provide a device which facilitates making a complex non-linear cut on a workpiece. Moreover, in this respect, it would be desirable to provide a device which facilitates automatically making a complex non-linear cut on a workpiece.

U.S. Pat. No. 3,840,170 discloses a device for automatically making a simple circumferential cut on a cylindrical workpiece. In contrast, however, it would be desirable to provide a device which can automatically make a complex non-linear cut on a flat workpiece.

Still other features would be desirable in an automatic workpiece cutting apparatus. The automatic devices discussed above cut a workpiece essentially in single direction. Yet there can be complex patterns on a flat workpiece that can require cutting in multiple directions. In this respect, it would be desirable to provide a device which automatically cuts a complex pattern on a flat workpiece by moving the cutting portion of the device in multiple directions when required.

Considering a hand-held jig saw, when such a saw is used manually, the jig saw is rotated in multiple directions to cut a multidirectional pattern in a flat workpiece. In this respect, it would be desirable if a device were provided which enables automatic rotation of a jig saw unit that is used to automatically cut a complex multidirectional pattern on a flat workpiece.

Computer controlled cutting machines are known wherein a complex cutting pattern is programmed into the computer controlled machine. To avoid the complexities required related to computer programming of complex patterns, it would be desirable if an automatic cutting machine were provided which does not require complex computer programming for complex patterns.

A workman can write any pattern, simple or complex, on a flat surface workpiece. Once a pattern is written on the workpiece, it would be desirable if a device could automatically cut out the workpiece in accordance with the pattern written on the workpiece.

It is known from analytic geometry that any point on a plane can be described by a vertical coordinate and a horizontal coordinate. More specifically, any pattern on a flat surface can be described in terms of a series of vertical and horizontal coordinates. In addition, any pattern on a two-dimensional surface can be followed by a device which is free to move in a vertical direction and is free to move in a horizontal direction wherein vertical and horizontal movement are independent of each other. In this respect, it would be desirable if a device were provided which includes two-dimensional movement of a cutting device wherein movement in one dimension is independent of movement on the other dimension.

Thus, while the foregoing body of prior art indicates it to be well known to use devices for automatically cutting a workpiece, the prior art described above does not teach or suggest an automatic workpiece cutting apparatus which has the following combination of desirable features: (1) provides a machine to automatically cut complex patterns in a workpiece with avoiding the need to stress and to fatigue a workman during a complex manual cutting operation; (2) facilitates making a complex non-linear cut on a workpiece; (3) facilitates automatically making a complex non-linear cut on a workpiece; (4) automatically makes a complex non-linear cut on a flat workpiece; (5) automatically cuts a complex pattern on a flat workpiece by moving the cutting portion of the device in multiple directions when required; (6) enables automatic rotation of a jig saw unit that is used to automatically cut a complex multidirectional pattern on a flat workpiece; (7) which does not require complex computer programming for complex patterns; (8) can automatically cut out a workpiece in accordance with a pattern written on the workpiece; and (9) provides two-dimensional movement of a cutting device wherein movement in one dimension is independent of movement on the other dimension. The foregoing desired characteristics are provided by the unique automatic workpiece cutting apparatus of the present invention as will be made apparent from the following description thereof. Other advantages of the present invention over the prior art also will be rendered evident.

### SUMMARY OF THE INVENTION

To achieve the foregoing and other advantages, the present invention, briefly described, provides an automatic cutting apparatus for cutting a workpiece which includes means for marking the workpiece, means for supporting the workpiece, a cutting tool unit, and means connected to the cutting tool unit for supporting and rotating the cutting tool unit. Means are connected to the cutting tool unit rotation means for supporting the cutting tool unit rotation means and for moving the cutting tool unit in a first linear direction. Carriage means are connected to the first-linear-direction cutting tool unit moving means for carrying the first-linear-direction cutting tool unit moving means. Means are connected to the carriage means for moving the carriage means in a second linear direction. Directional drive means are connected to the carriage means and to the cutting tool unit rotation means for respectively moving the carriage means along the means for moving the cutting tool unit in a second linear direction and for moving the cutting tool unit along the means for moving the cutting tool unit in a first linear direction. A marked line sensor unit is connected to the cutting tool unit. The directional drive means are responsive to the marked line sensor unit which is responsive to the marked workpiece.

The means for marking a workpiece can include a marking ink and a marking pen which contains a quantity of the marking ink. The marked line sensor unit can be an optical sensor unit. The means for supporting the workpiece can include a saw table. The second linear direction is perpendicular to the first linear direction.

Preferably, the marked line sensor unit is an optical sensor unit which includes a light source and a reflected light reader. The light source projects a sensing light beam onto the marking ink line on the marked workpiece, and the marking ink line reflects light from the light source, such that the reflected light is sensed by the reflected light reader. The light source can be a laser light source.

Preferably, the directional drive means include an electrically powered drive assembly. The electrically powered drive assembly is supported by the saw table. The electrically powered drive assembly is controlled by electrical control unit.

In this way, the automatic workpiece cutting apparatus causes the cutting tool blade of the cutting tool unit to automatically advance along the marking ink line and cut the workpiece in accordance with the marked pattern on the workpiece without human hands guiding the cutting tool unit.

The above brief description sets forth rather broadly the more important features of the present invention in order that the detailed description thereof that follows may be better understood, and in order that the present contributions to the art may be better appreciated. There are, of course, additional features of the invention that will be described hereinafter and which will be for the subject matter of the claims appended hereto.

In this respect, before explaining a preferred embodiment of the invention in detail, it is understood that the invention is not limited in its application to the details of the construction and to the arrangements of the components set forth in the following description or illustrated in the drawings. The invention is capable of other embodiments and of being practiced and carried out in various ways. Also, it is to be understood, that the phraseology and terminology employed herein are for the purpose of description and should not be regarded as limiting.

As such, those skilled in the art will appreciate that the conception, upon which disclosure is based, may readily be utilized as a basis for designing other structures, methods, and systems for carrying out the several purposes of the present invention. It is important, therefore, that the claims be regarded as including such equivalent constructions insofar as they do not depart from the spirit and scope of the present invention.

It is therefore an object of the present invention to provide a new and improved automatic workpiece cutting apparatus which has all of the advantages of the prior art and none of the disadvantages.

It is another object of the present invention to provide a new and improved automatic workpiece cutting apparatus which may be easily and efficiently manufactured and marketed.

It is a further object of the present invention to provide a new and improved automatic workpiece cutting apparatus which is of durable and reliable construction.

An even further object of the present invention is to provide a new and improved automatic workpiece cutting apparatus which is susceptible of a low cost of manufacture with regard to both materials and labor, and which accordingly is then susceptible of low prices of sale to the consuming public, thereby making such automatic workpiece cutting apparatus available to the buying public.

Still yet a further object of the present invention is to provide a new and improved automatic workpiece cutting apparatus which provides a machine to automatically cut complex patterns in a workpiece with avoiding the need to stress and to fatigue a workman during a complex manual cutting operation.

Still another object of the present invention is to provide a new and improved automatic workpiece cutting apparatus that facilitates making a complex non-linear cut on a workpiece.

Yet another object of the present invention is to provide a new and improved automatic workpiece cutting apparatus which facilitates automatically making a complex non-linear cut on a workpiece.

Even another object of the present invention is to provide a new and improved automatic workpiece cutting apparatus that automatically makes a complex non-linear cut on a flat workpiece.

Still a further object of the present invention is to provide a new and improved automatic workpiece cutting apparatus which automatically cuts a complex pattern on a flat workpiece by moving the cutting portion of the device in multiple directions when required.

Yet another object of the present invention is to provide a new and improved automatic workpiece cutting apparatus that enables automatic rotation of a jig saw unit that is used to automatically cut a complex multidirectional pattern on a flat workpiece.

Still another object of the present invention is to provide a new and improved automatic workpiece cutting apparatus which does not require complex computer programming for complex patterns.

Yet another object of the present invention is to provide a new and improved automatic workpiece cutting apparatus that can automatically cut out a workpiece in accordance with a pattern written on the workpiece.

Still a further object of the present invention is to provide a new and improved automatic workpiece cutting apparatus that provides two-dimensional movement of a cutting device wherein movement in one dimension is independent of movement on the other dimension.

These together with still other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The invention will be better understood and the above objects as well as objects other than those set forth above will become more apparent after a study of the following detailed description thereof. Such description makes reference to the annexed drawing wherein:

FIG. 1 is a side view showing a preferred embodiment of the automatic workpiece cutting apparatus of the invention.

FIG. 2 is a front view of the embodiment of the automatic workpiece cutting apparatus shown in FIG. 1 taken along line 2-2 of FIG. 1.

FIG. 3 is a perspective view of a workpiece being marked with marking ink using a marking pen.

FIG. 4 is an enlarged partial cross-sectional view of the embodiment of the invention shown in FIG. 2 taken along line 4-4 thereof.

FIG. 5 is an enlarged, partial perspective view of the embodiment of the invention shown in FIGS. 1-4 in use cutting the marked workpiece.

### DESCRIPTION OF THE PREFERRED EMBODIMENT

With reference to the drawings, a new and improved automatic workpiece cutting apparatus embodying the principles and concepts of the present invention will be described.

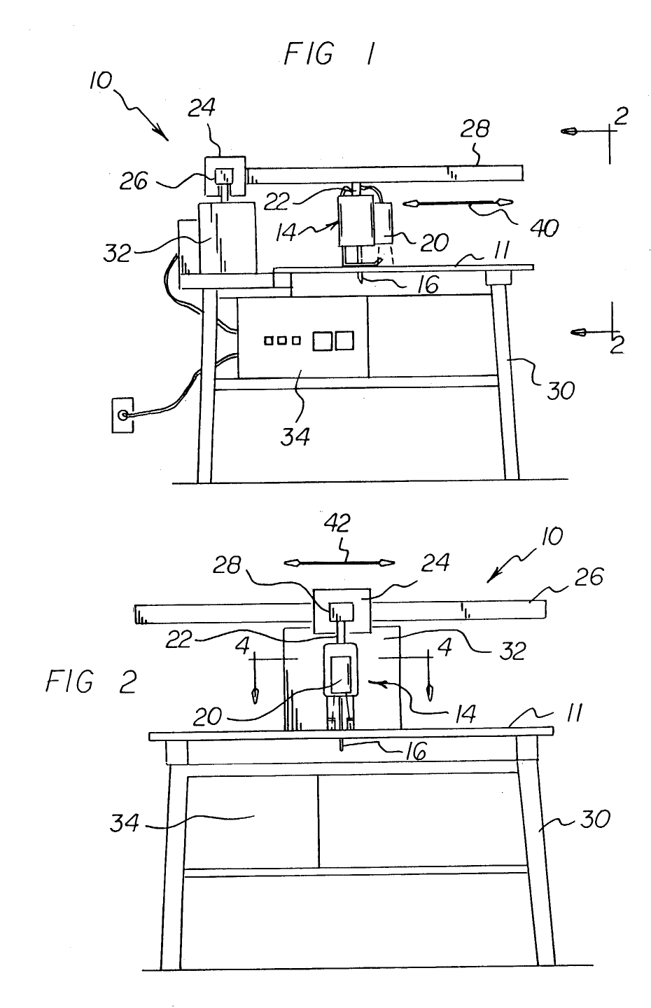

Turning to FIGS. 1-5, there is shown an exemplary embodiment of the automatic workpiece cutting apparatus of the invention generally designated by reference numeral 10. In its preferred form, an automatic cutting apparatus 10 is provided for cutting a workpiece 11 and includes means for marking the workpiece, means for supporting the workpiece, a cutting tool unit 14, and means connected to the cutting tool unit 14 for supporting and rotating the cutting tool unit 14. Means are connected to the cutting tool unit rotation means for supporting the cutting tool unit rotation means and for moving the cutting tool unit 14 in a first linear direction. Carriage means are connected to the first-linear-direction cutting tool unit moving means for carrying the first-linear-direction cutting tool unit moving means. Means are connected to the carriage means for moving the carriage means in a second linear direction. Directional drive means are connected to the carriage means and to the cutting tool unit rotation means for respectively moving the carriage means along the means for moving the cutting tool unit 14 in a second linear direction and for moving the cutting tool unit 14 along the means for moving the cutting tool unit 14 in a first linear direction. A marked line sensor unit 20 is connected to the cutting tool unit 14. The directional drive means are responsive to the marked line sensor unit 20 which is responsive to the marked workpiece 11.

The means for marking a workpiece can include a marking ink and a marking pen 18 which contains a quantity of the marking ink. The marked line sensor unit 20 can be an optical sensor unit. The means for supporting the workpiece can include a saw table 30. The second linear direction is perpendicular to the first linear direction.

Preferably, the marked line sensor unit 20 is an optical sensor unit which includes a light source and a reflected light reader. The light source projects a sensing light beam 36 onto the marking ink line 12 on the marked workpiece 11, and the marking ink line 12 reflects light from the light source, such that the reflected light is sensed by the reflected light reader. The light source can be a laser light source.

Preferably, the directional drive means include an electrically powered drive assembly 32. The electrically powered drive assembly 32 is supported by the saw table 30. The electrically powered drive assembly 32 is controlled by electrical control unit 34.

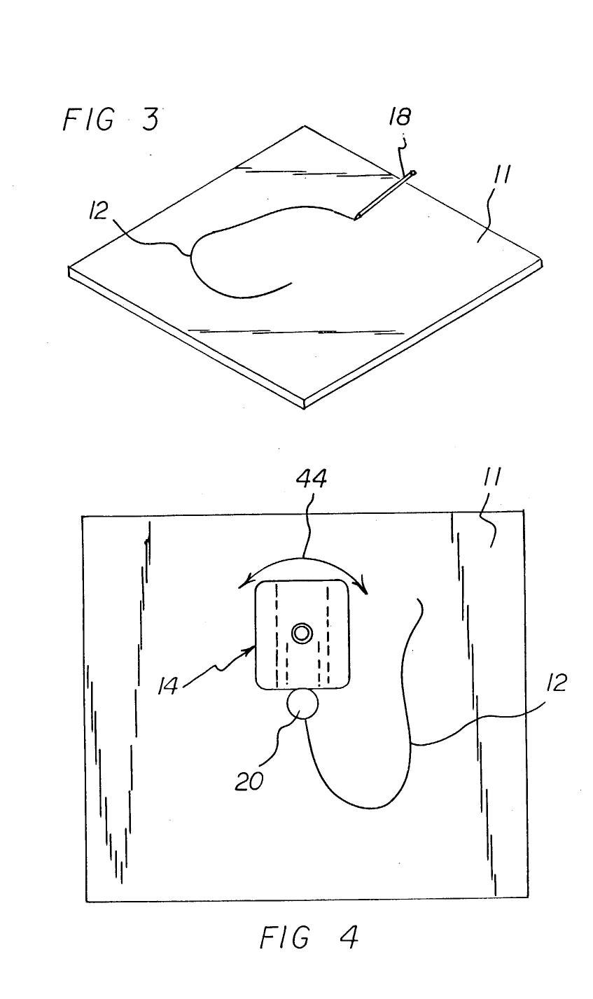

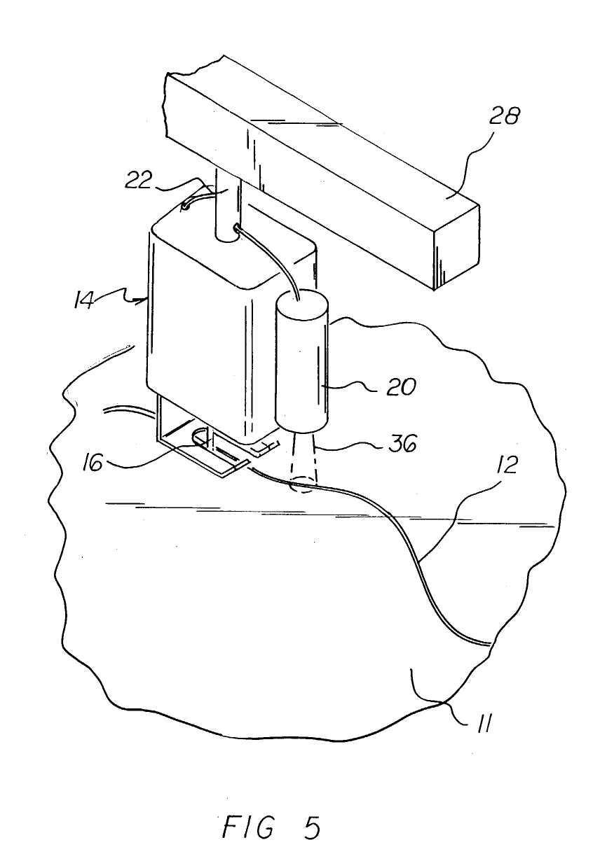

To use the automatic workpiece cutting apparatus 10 of the invention, a workpiece 11 is selected, and a marking pen 18 is used to apply a marking ink 12, in the form of a line, to the workpiece 11 in a pattern to be cut by the cutting tool blade 16, as shown in FIGS. 3 and 5. As shown in the figures, the marking ink line 12 can be curved, straight, and irregularly shaped. The marked workpiece 11 is placed on the saw table 30. Then, the cutting tool unit 14 is moved by hand along the first linear direction beam 28, and the first linear direction beam 28 is moved by hand along the second linear direction beam 26, using the intervening first beam carriage 24, so that the cutting tool blade 16 is placed upon the marking ink 12. The cutting tool unit 14 moves along the first linear direction beam 28 in directions shown by first directional arrows 40. The first beam carriage 24 moves along the second linear direction beam 26 in directions shown by second directional arrows 42.

Then, the cutting tool unit 14 is turned “on”. As the cutting tool blade 16 cuts through the workpiece 11 along the marking ink line 12, the marked line sensor unit 20 emits a sensing light beam 36 from its light source, and the sensing light beam 36 falls upon the marking ink line 12. A portion of the emitted light is reflected off of the marking ink line 12 back to the marked line sensor unit 20 which includes a reflected light reader. The reflected light reader serves to control the operation of the directional drive means to drive the cutting tool unit 14 so that the cutting tool blade 16 automatically follows along the marking ink line 12 and automatically cuts the workpiece 11 according to the pattern of the workpiece 11 marked by the marking ink line 12.

More specifically, the reflected light reader controls the electrically powered drive assembly 32 for automatically moving the first beam carriage 24 along the second linear direction beam 26 and for automatically moving the cutting tool unit 14 along the first linear direction beam 28 which is supported by the second linear direction beam 26.

The electrical control unit 34 is used for controlling relevant parameters of the light source and the reflected light reader in the marked line sensor unit 20. The electrical control unit 34 is also used for controlling drive motors that operate the first beam carriage 24 along the second linear direction beam 26 and that operate the cutting tool unit 14 along the first linear direction beam 28. As the cutting tool blade 16 automatically moves along the marking ink line 12, the cutting tool unit 14 automatically rotates around the rotatable shaft 22, as shown by rotational directional arrow 44.

In this way, the automatic workpiece cutting apparatus 10 causes the cutting tool blade 16 of the cutting tool unit 14 to automatically advance along the marking ink line 12 and cut the workpiece 11 in accordance with the marked pattern on the workpiece 11 without human hands guiding the cutting tool unit 14.

As shown in the drawing figures, the cutting tool unit 14 can be a saw unit 14, and the cutting tool blade 16 can be a saw blade 16. More specifically, the saw unit 14 can be a jigsaw unit, and the saw blade 16 can be a jigsaw blade 16. Even more specifically, the jigsaw unit can be a table-mounted jigsaw unit.

The components of the automatic workpiece cutting apparatus of the invention can be made from inexpensive and durable metal and plastic materials.

As to the manner of usage and operation of the instant invention, the same is apparent from the above disclosure, and accordingly, no further discussion relative to the manner of usage and operation need be provided.

It is apparent from the above that the present invention accomplishes all of the objects set forth by providing a new and improved automatic workpiece cutting apparatus that is low in cost, relatively simple in design and operation, and which may advantageously be used to cut complex patterns in a workpiece with avoiding the need to stress and to fatigue a workman during a complex manual cutting operation. With the invention, an automatic workpiece cutting apparatus is provided which facilitates making a complex non-linear cut on a workpiece. With the invention, an automatic workpiece cutting apparatus is provided which facilitates automatically making a complex non-linear cut on a workpiece. With the invention, an automatic workpiece cutting apparatus is provided which automatically makes a complex non-linear cut on a flat workpiece. With the invention, an automatic workpiece cutting apparatus is provided which automatically cuts a complex pattern on a flat workpiece by moving the cutting portion of the device in multiple directions when required. With the invention, an automatic workpiece cutting apparatus is provided which enables automatic rotation of a jig saw unit that is used to automatically cut a complex multidirectional pattern on a flat workpiece. With the invention, an automatic workpiece cutting apparatus is provided which does not require complex computer programming for complex patterns. With the invention, an automatic workpiece cutting apparatus is provided which can automatically cut out a workpiece in accordance with a pattern written on the workpiece. With the invention, an automatic workpiece cutting apparatus provides two-dimensional movement of a cutting device wherein movement in one dimension is independent of movement on the other dimension.

Thus, while the present invention has been shown in the drawings and fully described above with particularity and detail in connection with what is presently deemed to be the most practical and preferred embodiment(s) of the invention, it will be apparent to those of ordinary skill in the art that many modifications thereof may be made without departing from the principles and concepts set forth herein, including, but not limited to, variations in size, materials, shape, form, function and manner of operation, assembly and use.

Hence, the proper scope of the present invention should be determined only by the broadest interpretation of the appended claims so as to encompass all such modifications as well as all relationships equivalent to those illustrated in the drawings and described in the specification.

Finally, it will be appreciated that the purpose of the annexed Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. Accordingly, the Abstract is neither intended to define the invention or the application, which only is measured by the claims, nor is it intended to be limiting as to the scope of the invention in any way.

What is claimed as being new and desired to be protected by Letters Patent of the united states is as follows:

1. An automatic cutting apparatus for cutting a workpiece, comprising:
means for marking the workpiece,
means for supporting the workpiece,
a cutting tool unit,
means, connected to said cutting tool unit, for supporting and rotating said cutting tool unit,
means, connected to said cutting tool unit rotation means, for supporting said cutting tool unit rotation means and for moving said cutting tool unit in a first linear direction,
carriage means, connected to said first-linear-direction cutting tool unit moving means, for carrying said first-linear-direction cutting tool unit moving means,
means, connected to said carriage means, for moving said carriage means in a second linear direction,
directional drive means, connected to said carriage means and to said cutting tool unit rotation means, for respectively moving said carriage means along said means for moving said cutting tool unit in a second linear direction, and for moving said cutting tool unit along said means for moving said cutting tool unit in a first linear direction, and
a marked line sensor unit connected to said cutting tool unit, wherein said directional drive means are responsive to the marked workpiece.

2. The apparatus of claim 1 wherein said means for marking a workpiece include a marking ink and a marking pen which contains a quantity of said marking ink.

3. The apparatus of claim 1 wherein said marked line sensor unit is an optical sensor unit.

4. The apparatus of claim 1 wherein said means for supporting the workpiece include a saw table.

5. The apparatus of claim 1 wherein said second linear direction is perpendicular to said first linear direction.

6. The apparatus of claim 1 wherein:
said marked line sensor unit is an optical sensor unit which includes a light source and a reflected light reader, wherein said light source projects a sensing light beam, and
said marked workpiece includes markings that reflect light from said light source, such that said reflected light is sensed by said reflected light reader.

7. The apparatus of claim 6 wherein said light source can be a laser light source.

8. The apparatus of claim 1 wherein said directional drive means include an electrically powered drive assembly.

9. The apparatus of claim 8 wherein said electrically powered drive assembly is supported by said saw table.

10. The apparatus of claim 8 wherein said electrically powered drive assembly is controlled by an electrical control unit.
